(19) United States
(12) Patent Application Publication
(10) Pub. No.: US 2024/0289813 A1
(43) Pub. Date: Aug. 29, 2024

(54) INTERPRETER SERVICES LIFECYCLE APPLICATIONS AND ENVIRONMENT

(71) Applicant: INTERP, LLC, Alpharetta, GA (US)

(72) Inventors: Gavaskar Sharp, Johns Creek, GA (US); Brandi Ruff, Johns Creek, GA (US)

(21) Appl. No.: 18/588,498

(22) Filed: Feb. 27, 2024

Related U.S. Application Data
(60) Provisional application No. 63/487,116, filed on Feb. 27, 2023.

(51) Int. Cl. G06Q 30/015; H04L 67/52; H04L 67/61

(52) U.S. Cl. CPC G06Q 30/015; H04L 67/52; H04L 67/61

(57) ABSTRACT

A method and system for lifecycle management and tracking of services are disclosed. The method includes onboarding service providers and service requesters, storing their data, and receiving a service request from a service requester. The request is matched to a subset of service providers, who are then surfaced for selection. Upon selection of a service provider, the provider is notified of the selection and the start of services. A start acceptance is received from the service provider, and geolocation data of the service provider is tracked after receipt of the start acceptance. The service requester is notified of the start acceptance and an estimated arrival of the service provider. Arrival and services completion confirmations are received from the service provider.

### CROSS-REFERENCE TO RELATED APPLICATION

This application claims the benefit of and priority to U.S. Provisional Patent Application No. 63/487,116 filed Feb. 27, 2023 entitled “INTERPRETER SERVICES LIFECYCLE APPLICATIONS AND ENVIRONMENT,” the contents of which being incorporated by reference in its entirety herein.

### TECHNICAL FIELD

The present disclosure generally relates to the field of service lifecycle management in networked environments and, more specifically, to systems and methods for onboarding service providers and requesters, matching service requests to providers based on criteria-matching algorithms, and tracking the progress of service fulfillment using real-time geolocation data.

### BACKGROUND

In the modern era, a wide range of services are provided to customers by various service providers. These services can span numerous sectors, including but not limited to consulting, communications, data storage, and “big data” processing services. With the advent and widespread adoption of computing technologies, service providers have found innovative ways to integrate these technologies into the services they provide. This integration has led to the development of networked environments that facilitate the delivery of services.

Furthermore, the proliferation of client devices such as smartphones, laptops, tablets, and other computing devices has provided service providers with additional avenues for interfacing with their customers. These devices can be used to communicate information about the status of requested services, enhancing the overall customer experience. In particular, the use of real-time geolocation data has emerged as a valuable tool for tracking the progress of service fulfillment. This technology allows both service providers and customers to monitor the location of a service provider in real-time, providing a high degree of visibility into the status of services.

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a system for managing service provider lifecycles in a networked environment includes a computing environment configured to onboard service providers and service requesters and store their data. The system also includes a matching engine configured to receive a service request from a service requester and match the request to a subset of service providers based on specific criteria. The system further includes a lifecycle engine configured to notify the selected service provider of the selection and the start of services, receive a start acceptance from the service provider, track the geolocation data of the service provider after receipt of the start acceptance, notify the service requester of the start acceptance and an estimated arrival of the service provider based on the geolocation data, and receive arrival and services completion confirmations from the service provider.

According to other aspects of the present disclosure, the system may include specific criteria used by the matching engine comprising at least one of: proximity of the service providers to the requested service location, availability of the service providers during the requested service timeframe, and credentials of the service providers. The lifecycle engine may be further configured to provide real-time updates to the service requester and the service provider about the status of the service request.

According to another aspect of the present disclosure, a method for managing service provider lifecycles in a networked environment includes onboarding service providers and service requesters, storing their data, receiving a service request from a service requester, employing a machine learning algorithm to match the request to a subset of service providers based on specific criteria, compressing the matched service provider data before transmission to the service requester, notifying the selected service provider of the selection and the start of services, receiving a start acceptance from the service provider, tracking the geolocation data of the service provider after receipt of the start acceptance, notifying the service requester of the start acceptance and an estimated arrival of the service provider based on the geolocation data, and receiving arrival and services completion confirmations from the service provider.

According to other aspects of the present disclosure, the method may include the onboarding of service providers and service requesters involving collecting information about the service providers and service requesters, such as their credentials, availability, geographical location, and other relevant details. The geographical location data may be used for matching service requests to service providers based on proximity. The availability data may be used to match service requests to service providers based on the service providers' availability during the requested service timeframe.

The matching of the service request to a subset of service providers may be based on specific criteria including at least one of: proximity of the service providers to the requested service location, availability of the service providers during the requested service timeframe, credentials of the service providers, and machine learning predictions based on historical data. The tracking of the geolocation data of the service provider after receipt of the start acceptance may comprise using GPS technology to monitor the service provider's location in real-time. The arrival and services completion confirmations from the service provider may be received through manual confirmations by the service provider via a computing device. The machine learning algorithm may be configured to learn and adapt over time to improve the accuracy of matching service requests with service providers based on the specific criteria, and the data compression may comprise employing lossless data compression techniques to reduce the size of the matched service provider data without loss of information before transmission to the service requester.

According to various aspects, a method is described for optimizing network bandwidth and reducing central processing unit (CPU) or graphics processing unit (GPU) usage in a services lifecycle application within a networked environment. This method encompasses a series of processes designed to enhance the efficiency of data transmission and processing, thereby improving the overall performance of the system. The method includes transmitting incremental updates to client devices, which ensures that devices receive new or changed data since their last update, reducing unnecessary data transfer. Adaptive data synchronization is employed to adjust data transfers based on current network conditions and the priority of the data, which helps in maintaining network efficiency and responsiveness.

Furthermore, the method includes utilizing caching strategies to store frequently accessed data locally on client devices or using edge caching, which minimizes the number of data requests that travel back to the central server. Network traffic management techniques, such as traffic shaping and load balancing, are implemented to prioritize time-sensitive data and evenly distribute network traffic. Predictive analytics are leveraged to anticipate peak usage times, allowing for the pre-allocation of resources to handle demand surges without overwhelming the network. Efficient network protocols and protocol compression are utilized to enhance data transfer efficiency and reduce the size of network packets, contributing to the conservation of network bandwidth.

The foregoing general description of the illustrative embodiments and the following detailed description thereof are merely example embodiments of this disclosure and are not restrictive.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates a networked environment for interpreter services lifecycle management, featuring a central computing environment and multiple client computing devices.

FIG. 2 presents a flowchart of a method for lifecycle management and tracking of services, detailing various embodiments from onboarding to service completion.

FIGS. 3A-3B depict user interfaces for account login and account type selection within a mobile application.

FIGS. 3C-3D show user interfaces for account creation for service requesters and service providers.

FIGS. 3E-3F display user interfaces for a service provider's onboarding process, including address and availability input screens.

FIGS. 3G-3H present user interfaces for selecting areas of expertise and attaching verification documents during the onboarding process for service providers.

FIGS. 3I-3J depict user interfaces for a service provider's welcome screen and profile management screen within the application.

FIGS. 3K-3L illustrate user interfaces for service request and filter setting within the application.

FIGS. 3M-3R show user interfaces for notifying users about interpreter matches and providing route information for service fulfillment.

FIG. 4 presents a flowchart of a method for lifecycle management and tracking of services, detailing various embodiments from onboarding to service completion.

FIG. 5 presents a flowchart of a method for lifecycle management and tracking of services, detailing various embodiments from onboarding to service completion.

FIG. 6 presents a flowchart of a method for lifecycle management and tracking of services, detailing various embodiments from onboarding to service completion.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those example embodiments described herein.

With the advent and widespread adoption of computing technologies, service providers have found innovative ways to integrate these technologies into the services they provide. This integration has been further facilitated by the ubiquity of client devices such as smartphones, laptops, tablets, and other computing devices, which have opened up new avenues for service providers to interface with their customers and keep them updated about the status of the services requested.

However, despite these advancements, there are still challenges in the lifecycle management and tracking of services. For instance, there can be miscommunications between service providers and service requesters, leading to inefficiencies and increased costs. Furthermore, there is often a lack of visibility into the status of services, including the location of a service provider on the date of a service request. This lack of real-time information can lead to uncertainties and potential delays in service delivery. Additionally, matching service requests with appropriate service providers based on specific criteria can be a computationally intensive task, putting a strain on computing resources.

Therefore, there is a clear and present demand for a more efficient and effective method for lifecycle management and tracking of services. Such a method would ideally facilitate the onboarding of service providers and service requesters, enable the identification and selection of service providers that meet the criteria associated with a service request, and provide real-time notifications, tracking, and monitoring of the progress of the service request. This would not just enhance the performance of the computing device and optimize the use of computing resources, but also improve the overall service delivery process, thereby benefiting both service providers and service requesters.

When considering the services lifecycle management and tracking system described in various embodiments herein, several computing problems related to memory, central processing unit (CPU) usage, security, and other areas arise. With respect to memory usage, there is a data storage overhead where storing extensive service provider data, service requester data, and transactional data for each service request can lead to high memory usage, which can be costly and inefficient. There are caching inefficiencies where improper caching strategies might lead to redundant data storage or frequent cache misses, which can increase memory usage and latency. There are memory leaks where poorly managed memory allocation and deallocation could lead to memory leaks, where memory that is no longer in use is not released back to the system.

With respect to CPU usage, there are resource-intensive processes where matching algorithms and real-time data processing can be computationally intensive, leading to high CPU usage. There is concurrent processing where handling multiple service requests and tracking geolocation data concurrently can strain the CPU or graphics processing unit (GPU), especially during peak processing times. There can be inefficient code where unoptimized code can cause unnecessary CPU cycles, slowing down the system and affecting the user experience. These can impair operations of a computing device and, most notably, a mobile client device.

With respect to data security, there can be data breaches where storing sensitive information such as personal details, credentials, and geolocation data poses a risk of data breaches if not properly secured. There can be the threat of unauthorized access. Without robust authentication and authorization mechanisms, there's a risk of unauthorized access to the system, potentially leading to data manipulation or theft. There also should be data transmission security, where insecure data transmission methods can expose data to interception and tampering during communication between client devices and the server.

Other computing-related issues can include network bandwidth, latency, scalability issues, and reliability issues. With respect to network bandwidth, transmitting large amounts of data, especially geolocation updates, can consume substantial network bandwidth. With respect to latency, real-time tracking and notifications require low-latency communication, which can be challenging to maintain, especially with a high number of users. With respect to scalability, as the number of service providers and requesters grows, the system may struggle to scale efficiently if not designed with scalability in mind. With respect to reliability, the system's reliance on real-time geolocation and instant notifications means that any downtime or errors can severely impact the service lifecycle. With respect to energy consumption, for client devices, especially mobile devices, continuous tracking and data communication can lead to high energy consumption and battery drain.

To mitigate these issues, the system can implement various strategies, such as optimizing algorithms for better CPU and memory usage, employing secure data storage and transmission protocols, and designing scalable and fault-tolerant architectures. Additionally, the system can use data compression techniques to reduce the size of transmitted data, implement efficient caching mechanisms, and use predictive analytics to manage resources proactively.

The disclosed system and method can enhance the performance of a computing device and optimize the use of computing resources in several ways. By utilizing algorithms designed to match service requests with service providers based on specific criteria, the system can quickly identify the appropriate subset of service providers. This targeted approach reduces the computational load associated with processing large datasets, thereby conserving processing power. The system can employ data normalization and indexing within the cloud-based data store to streamline data retrieval and minimize storage overhead. Efficient data organization can lead to quicker access times and reduced memory usage. The system can be designed to send notifications and updates in a compressed format, reducing the size of data packets transmitted over the network. This approach minimizes bandwidth consumption and can decrease the likelihood of network congestion.

The system can implement caching mechanisms to store frequently accessed data locally on the computing device. This reduces the number of repeated queries to the server, saving bandwidth and reducing latency. The system can synchronize data between the service provider and service requester intelligently, based on network conditions and data priority. This adaptive synchronization can prevent unnecessary data transfers, conserving bandwidth and computing resources. The computing environment can distribute the workload across multiple servers or processing units, ensuring that no single device is overwhelmed. This can prevent performance bottlenecks and improve overall system responsiveness. By analyzing historical data and usage patterns, the system can predict peak times and pre-allocate resources accordingly.

This proactive resource management can prevent overuse of computing resources during high-demand periods. Instead of sending complete datasets, the system can be configured to send incremental updates to the client devices, ensuring that only the changes since the last update are transmitted. This reduces the data load and conserves network bandwidth. By implementing these strategies, the system can provide lifecycle management and tracking of services in a manner that is resource-efficient, reducing the computational burden on client devices and the overall network infrastructure.

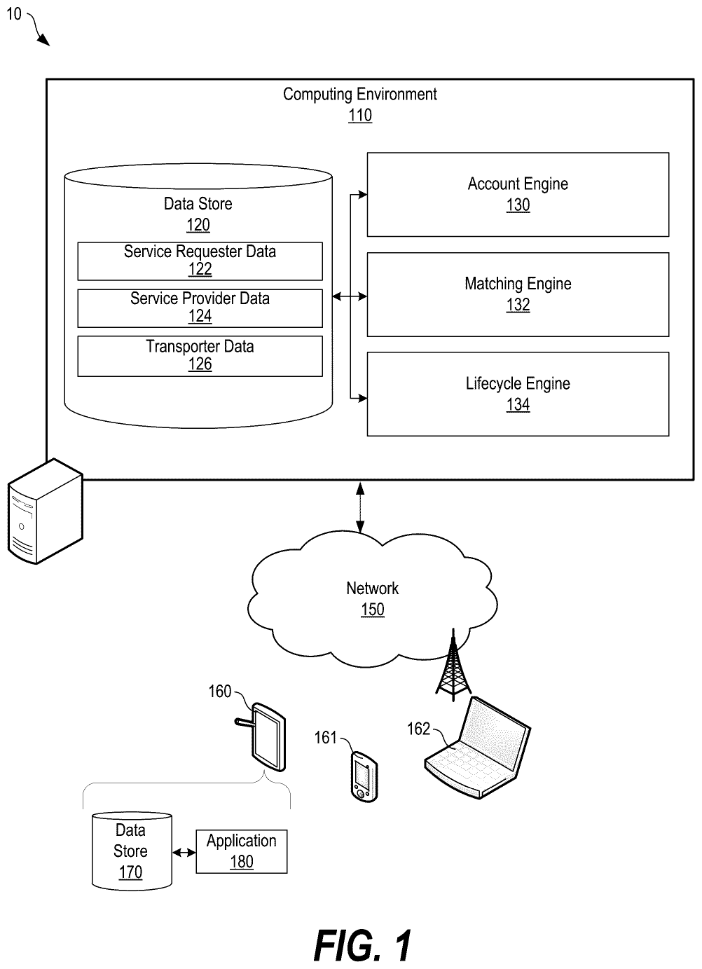

Referring to FIG. 1, an example networked environment 10 for services lifecycle establishment and control is illustrated. The networked environment 10 includes a computing environment 110, a network 150, and a number of client computing devices 160-162, among others, that are communicatively coupled to each other over the network 150. In some aspects, the computing environment 110 can be embodied as one or more computing environments, computer systems, computing devices, or processing systems or devices. The computing environment 110 can include one or more computing devices arranged, for example, in one or more server or computer banks.

The computing device or devices can be located at a single installation site or distributed among different geographical locations. The computing environment 110 can include a plurality of computing devices that together embody a hosted computing resource, a grid computing resource, or other distributed computing arrangement. In some cases, the computing environment 110 can be embodied as an elastic computing resource where an allotted capacity of processing, network, storage, or other computing-related resources varies over time.

The computing environment 110 includes a data store 120, an account engine 130, a matching engine 132, and a lifecycle engine 134. The data store 120 can be embodied as a memory, of any suitable type, and can be used to store data and data files, including service requester data 122, service provider data 124, transporter data 126, and other types of data. The account engine 130, matching engine 132, and lifecycle engine 134 are examples of applications or programs executable on the computing environment 110. The computing environment 110 can host and execute any number of applications concurrently, as would be understood in the field of computing.

The operations of the account engine 130, matching engine 132, and lifecycle engine 134 are described in greater detail below. The network 150 can include the Internet, intranets, extranets, wide area networks (WANs), local area networks (LANs), wired networks, wireless networks, cable networks, satellite networks, other suitable networks, or any combinations thereof. As one example, the computing environment 110 and the client devices 160-162 can be respectively coupled to one or more public or private LANs or WANs and, in turn, to the Internet for communication of data among each other using network interfaces.

Although not shown in FIG. 1, the network 150 can also include communicative connections to any number and type of network hosts or devices, such as website servers, file servers, cloud computing resources, databases, data stores, or any other network or computing architectures.

The client devices 160-162 are representative of various types of computing devices, processing devices, and/or processor-based device or systems, including those in the form of a desktop computer, a laptop computer, a tablet computer, a personal digital assistant, a cellular telephone, a wearable computing device, and other example computing devices and systems. Each of the client devices 160-162 can include one or more processors or processing devices, memory devices, local interfaces, various peripheral devices, and other components. The peripheral devices can include input or communications devices or modules, such as keyboards, touch pads, touch screens, microphones, cameras, network communications interfaces, wireless network communications modules, buttons, switches, sensors, etc.

The peripheral devices can also include a display, indicator lights, speakers, global positioning system (GPS) circuitry, accelerometers, gyroscopes, and other peripheral devices. The client devices 160-162 can be used by service providers, service requesters, and other parties. In the examples described below, the client device 160 is used by a service provider, and the client device 161 is used by a service requester. The client devices 160-162 can interface with the computing environment 110 to request services and monitor and track the lifecycle of the services, as described herein.

The client devices 160-162 can present a variety of user interfaces to the parties based on functions performed and actions taken by the account engine 130, matching engine 132, and lifecycle engine 134. The matching engine 132 is configured to receive service requests from service requesters. For example, the matching engine 132 is configured to direct an application on the client device 161 to present one or more user interfaces related to a new request for services. The matching engine 132 can store information and data associated each service request in the data store 120 for further evaluation and processing.

The matching engine 132 is also configured to receive and match service requests from service requesters to one or more service providers that are capable of performing the requested services. The matching engine 132 can match service requests to service providers based on a range of factors, such as proximity of the service providers to the requested service location, the availability of service requesters on a service date and at a service time, the costs of service requesters, the credentials or capabilities of service providers, the ratings associated with service providers, and other criteria.

To perform the matching of service requests to service providers, the matching engine 132 can employ a variety of machine learning routines tailored to the specific characteristics and requirements of the service lifecycle management system. Supervised learning techniques, such as classification algorithms like support vector machines, decision trees, or random forests, can be used to categorize service providers based on predefined features. Regression algorithms, including linear regression or gradient boosting, can be used to predict continuous outcomes, such as estimating the cost or time efficiency of a service provider prior to booking or for administrative viewing.

Unsupervised learning approaches, like clustering algorithms (e.g., K-means or hierarchical clustering), can be utilized by the matching engine 132 to group similar service providers or requests to uncover patterns within the data. Dimensionality reduction techniques, such as principal component analysis or t-distributed stochastic neighbor embedding, can simplify the feature space for more effective pattern recognition. Reinforcement learning methods, such as multi-armed bandit algorithms and q-learning, can dynamically match service requests to providers by learning and adapting to maximize a reward function, such as customer satisfaction or speed of service delivery. Neural networks and deep learning models, such as feedforward neural networks (FNNs), convolutional neural networks (CNNs), and recurrent neural networks (RNNs) or long short-term memory networks (LSTMNs), can be utilized for complex pattern recognition and sequential data analysis, which can be particularly useful for matching based on historical performance or availability patterns.

Further, the matching engine 132 can perform natural language processing to enable the matching engine to process and understand service descriptions and provider profiles at a semantic level. Word embedding models, such as, but not limited to, Word2Vec or GloVe can convert textual information into numerical vectors, facilitating the matching of services with similar requirements or provider expertise based on the meaning of the text.

Ensemble methods, which combine multiple learning algorithms, can enhance the robustness and accuracy of the matching process. Techniques such as “boosting and bagging” can improve decision tree performance on complex matching problems, leading to more accurate and reliable matches between service requests and providers. By integrating these machine learning routines, the matching engine can optimize the matching process, reduce the time to calculate a match, and identify a highest statistical match, resulting in a more efficient and effective service lifecycle management system.

The lifecycle engine 134 can be configured to notify the service requester of the service request and confirm that the service request is accepted by the service provider. The lifecycle engine 134 is also configured to track the progress of the service request, the service provider's process in completing the service request, and the service provider's completion of the service request. The lifecycle engine 134 is also configured to provide real-time information to both the service provider and the service requester about the services. The disclosed system and method can enhance the performance of a computing device and optimize the use of computing resources in several ways. By utilizing algorithms designed to match service requests with service providers based on specific criteria, the system can quickly identify the appropriate subset of service providers. This targeted approach reduces the computational load associated with processing large datasets, thereby conserving processing power.

The system can employ data normalization and indexing within the cloud-based data store to streamline data retrieval and minimize storage overhead. Efficient data organization can lead to quicker access times and reduced memory usage. The system can be designed to send notifications and updates in a compressed format, reducing the size of data packets transmitted over the network. This approach minimizes bandwidth consumption and can decrease the likelihood of network congestion. The system can implement caching mechanisms to store frequently accessed data locally on the computing device. This reduces the number of repeated queries to the server, saving bandwidth and reducing latency. The system can synchronize data between the service provider and service requester intelligently, based on network conditions and data priority. This adaptive synchronization can prevent unnecessary data transfers, conserving bandwidth and computing resources.

The computing environment can distribute the workload across multiple servers or processing units, ensuring that no single device is overwhelmed. This can prevent performance bottlenecks and improve overall system responsiveness. By analyzing historical data and usage patterns, the system can predict peak times and pre-allocate resources accordingly. This proactive resource management can prevent overuse of computing resources during high-demand periods. Instead of sending complete datasets, the system can be configured to send incremental updates to the client devices, ensuring that the changes since the last update are transmitted. This reduces the data load and conserves network bandwidth.

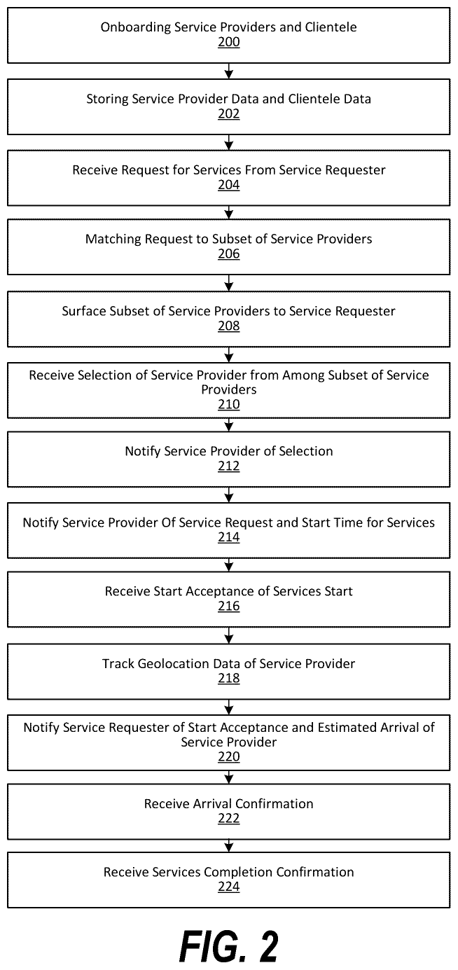

Referring to FIG. 2, an example method for services lifecycle establishment and control is illustrated. The method begins with the Onboarding Step 200, where service providers and service requesters may be onboarded into the system. In some cases, the onboarding process may involve collecting information about the service providers and service requesters, such as their credentials, availability, geographical location, and other relevant details. Following the onboarding, the Data Storage Step 202 involves storing service provider data and service requester data based on the onboarding process.

The service provider data may include service provider availability criteria, service provider credential criteria, and service provider location criteria. Similarly, the service requester data may include details about the type of service requested, the date and time of the service, and the location where the service is to be provided. The Service Request Receipt Step 204 is where a service request is received from a service requester. The service request may include a service type, a service date, a service timeframe, and a service location.

In some aspects, the service request may be a request for an interpreter, such as an ASL interpreter, to arrive at a conference, deposition, court hearing, or other event at which interpretation services are desired. Next, the Service Provider Matching Step 206 matches the request to a subset of service providers. The matching of the service request to a subset of service providers may be based on various factors. In some cases, these factors may include the proximity of the service providers to the requested service location, the availability of the service providers during the requested service timeframe, and the credentials of the service providers.

The Service Provider Surfacing Step 208 surfaces this subset of service providers for selection by the service requester. The service requester may be presented with a list of service providers who are capable of fulfilling the service request, and they may select a service provider from this list. The Service Provider Selection Receipt Step 210 is where a selection of a service provider from among the subset is received. The selected service provider may then be notified of the selection in the Service Provider Notification Step 212. The notification may be sent to the service provider's computing device, informing them that they have been selected to fulfill the service request.

The Service Start Notification Step 214 notifies the service provider of the service request and start time for services. The Start Acceptance Receipt Step 216 is where a start acceptance from the service provider is received. Upon receipt of the start acceptance, Geolocation Tracking Step 218 tracks the geolocation data of the service provider. This may involve using GPS technology to monitor the service provider's location in real-time. The Service Requester Notification Step 220 notifies the service requester of the start acceptance and an estimated arrival of the service provider based on the geolocation data. The Arrival Confirmation Receipt Step 222 is where an arrival confirmation from the service provider is received. Finally, the Service Completion Confirmation Receipt Step 224 is where a services completion confirmation from the service provider is received.

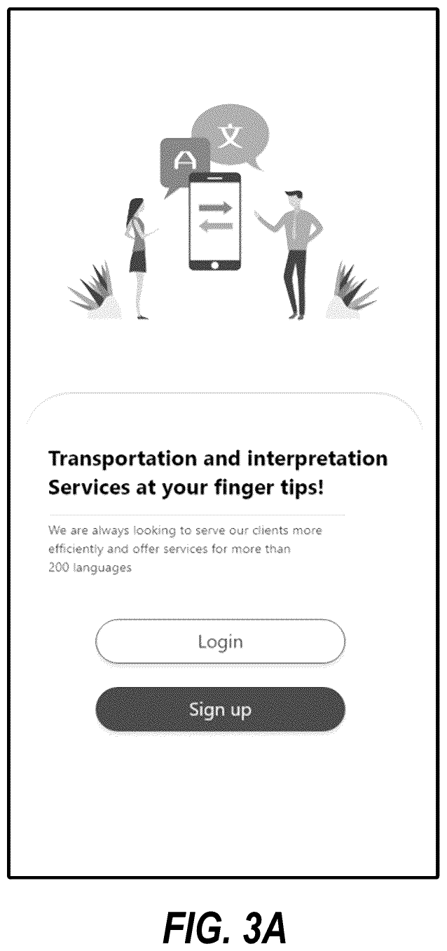

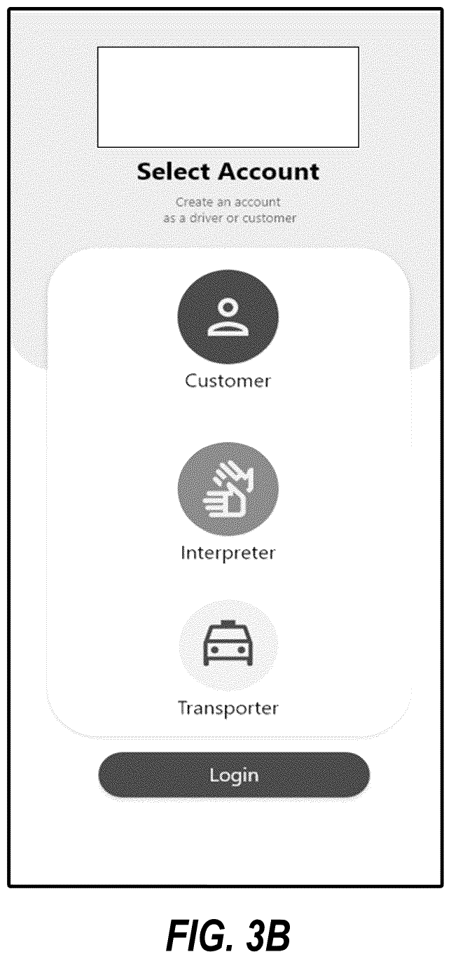

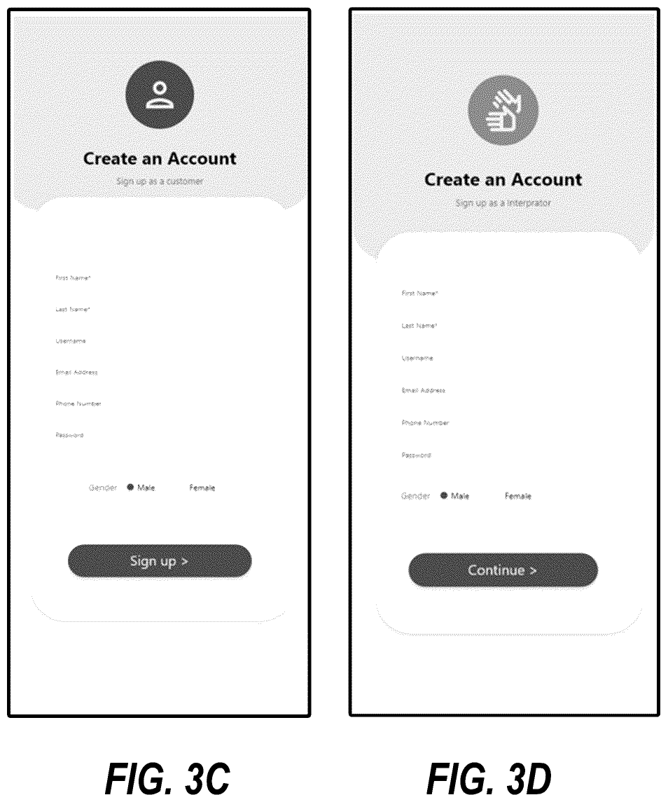

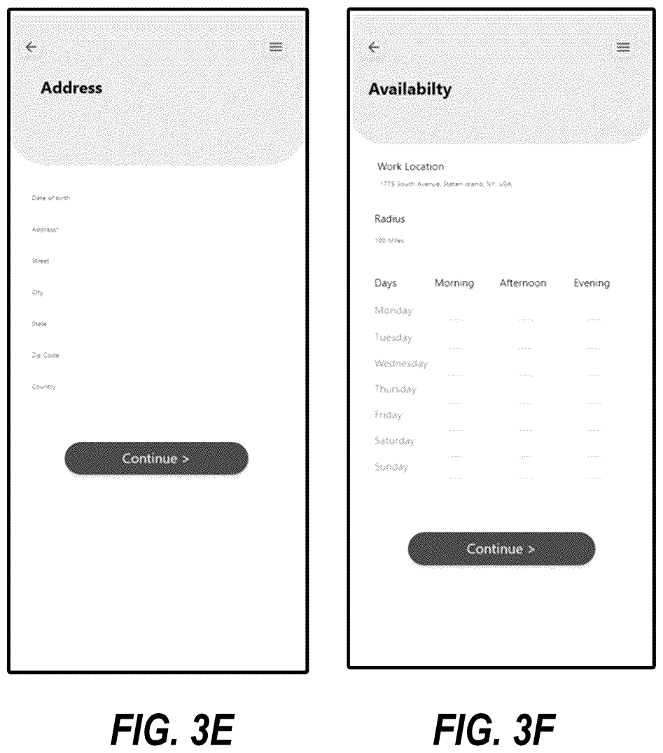

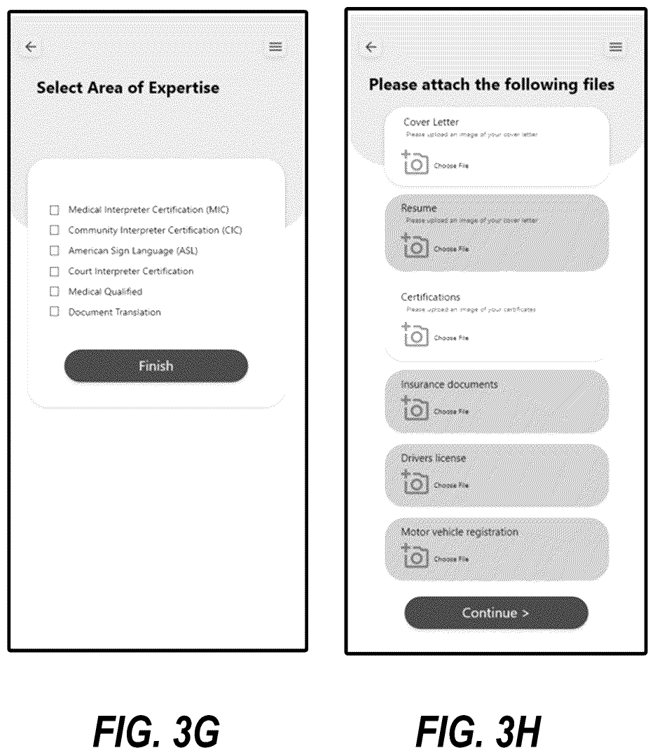

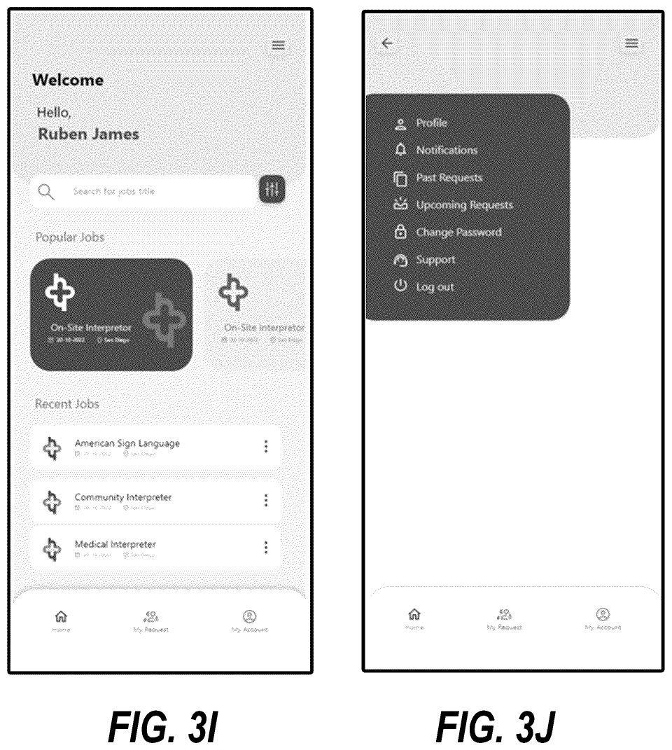

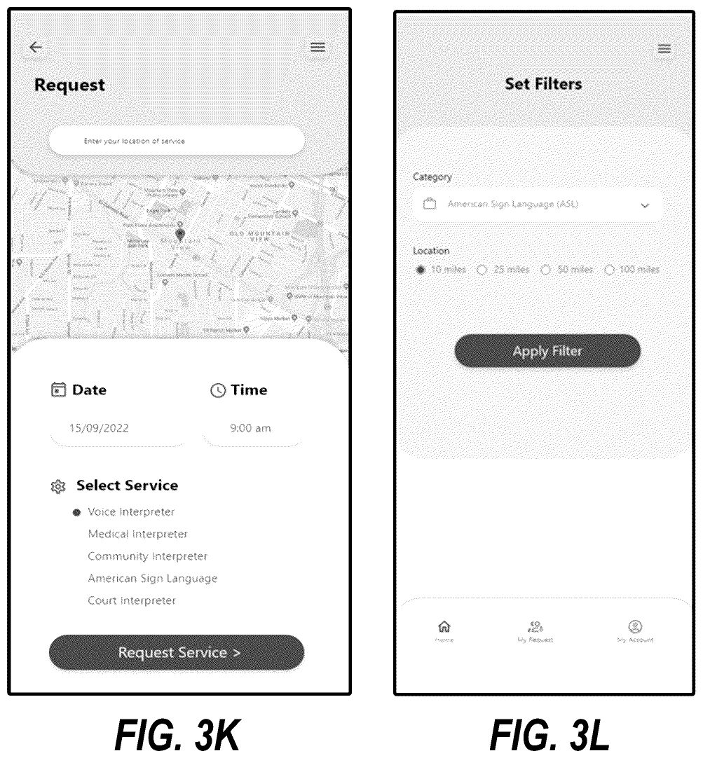

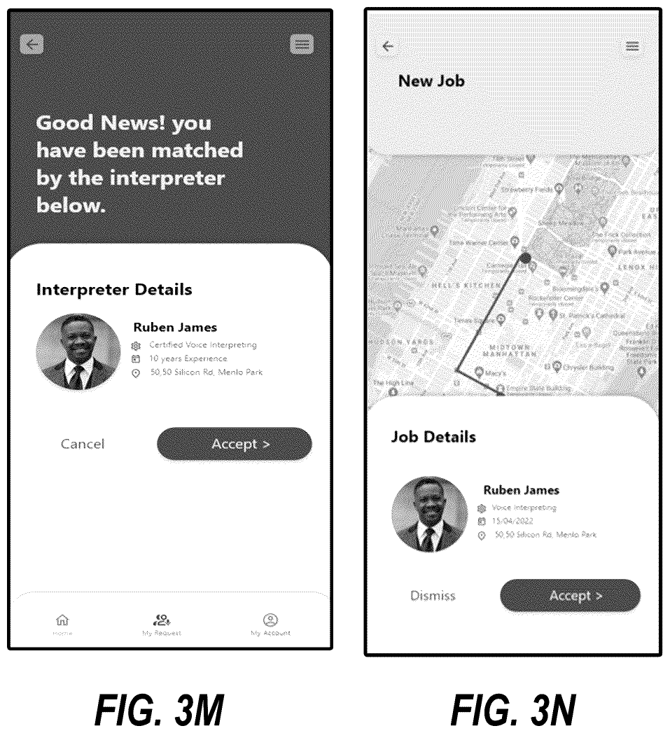

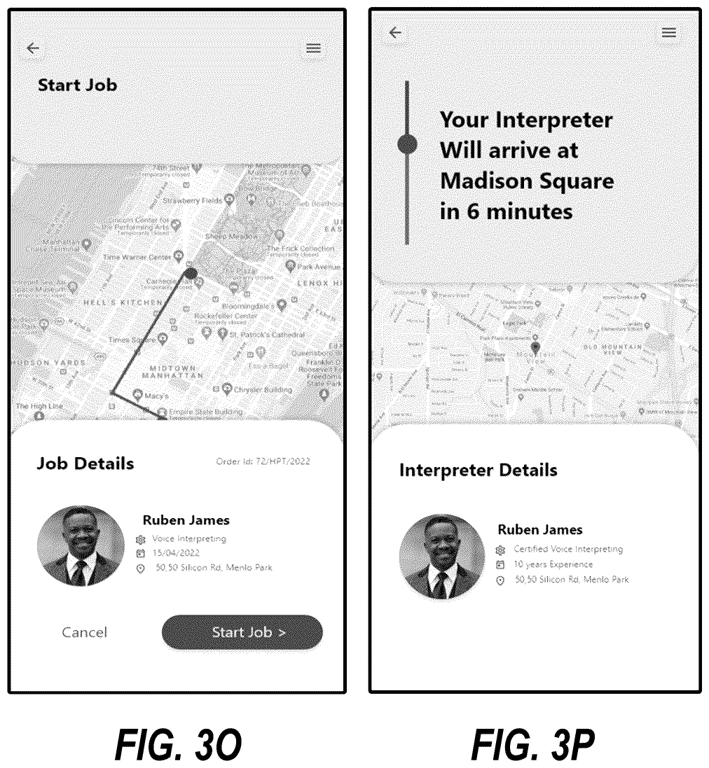

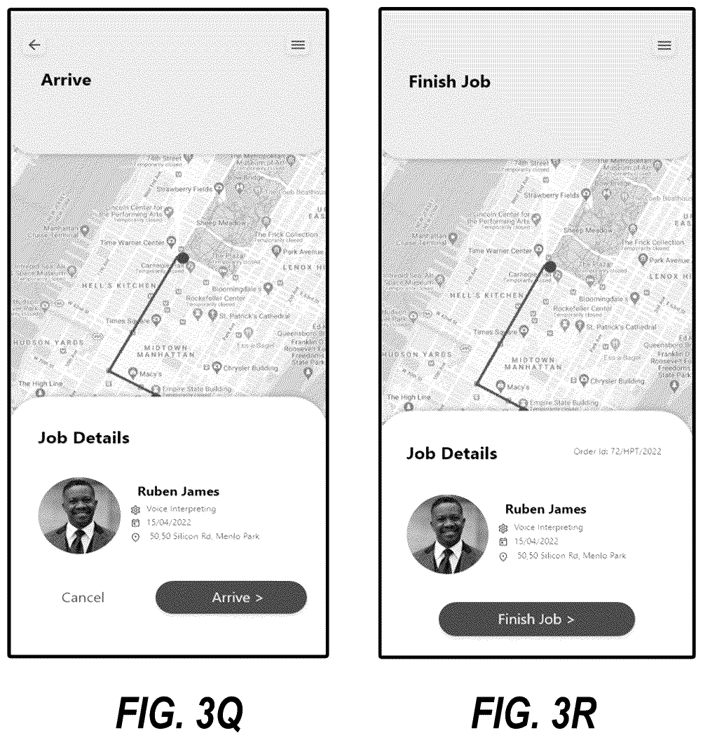

Referring to FIG. 3A, an example user interface for a mobile application is depicted. In some cases, the user interface may include two selectable buttons labeled “Login” and “Sign up.” These buttons may lead to functionality for existing users to access their accounts and for new users to create accounts, respectively. The “Login” button may be selected by users who already have an account with the application, allowing them to enter their login credentials and access their account. On the other hand, the “Sign up” button may be selected by users who do not yet have an account with the application, guiding them through the process of creating a new account.

In this way, the user interface depicted in FIG. 3A may facilitate user interaction with the application, enabling both new and existing users to access the services provided by the application. Referring to FIG. 3B, an example user interface for selecting an account type within a mobile application is depicted. In some aspects, the user interface may present three options: “Customer,” “Interpreter,” and “Transporter,” each represented by an icon and label, although it is understood that other options can be available. These options may correspond to different types of users who may interact with the application. For instance, a “Customer” may be a service requester who is seeking to avail of services provided by interpreters or transporters.

An “Interpreter” may be a service provider who offers interpretation services, while a “Transporter” may be a service provider who offers transportation services. In some cases, the user interface may include a “Login” button located below the account type options. This button may indicate that users have the option to either create a new account as one of the three types or log in to an existing account. The process of creating a new account or logging into an existing account may involve entering relevant user information, such as a username and password. In some aspects, the layout of the user interface may suggest a straightforward and user-friendly process for account selection and access within the application.

The clear and intuitive design of the user interface may facilitate easy navigation for users, enabling them to quickly and efficiently select their account type and access their account. This may enhance the user experience and contribute to the overall efficiency and effectiveness of the services lifecycle management and tracking process.

Referring to FIGS. 3C-3D, example user interface screens for account creation within a service lifecycle application are depicted. In some aspects, FIG. 3C shows a user interface for a customer, or service requester, to create an account. This interface may include fields for entering personal information such as first name, last name, username, email address, phone number, and password. In some cases, the interface may also include a gender selection option with male and female choices.

The interface may conclude with a selectable button labeled “Sign up,” which a service requester may select to proceed with the account creation process. In some aspects, FIG. 3D displays a user interface for an interpreter, or service provider, to sign up. Similar to the interface shown in FIG. 3C, this interface may include fields for entering personal information such as first name, last name, username, email address, phone number, and password. In some cases, the interface may also include a gender selection option with male and female choices. The interface may conclude with a selectable button labeled “Continue,” which a service provider may select to proceed with the account creation process. In some aspects, the user interfaces shown in FIGS. 3C-3D may facilitate the onboarding of service providers and service requesters by providing a straightforward and user-friendly process for account creation.

The clear and intuitive design of the user interfaces may enable users to quickly and efficiently enter their personal information and create their accounts. This may enhance the user experience and contribute to the overall efficiency and effectiveness of the services lifecycle management and tracking process.

Referring to FIGS. 3E-3F, example user interface screens for a service provider's onboarding process within a service lifecycle application are depicted. In some aspects, FIG. 3E displays an address input screen where a service provider may enter their address details, including date of birth, street, city, state, and country, before proceeding by clicking the “Continue” button. This onboarding process may include collecting information about the service provider's geographical location. The geographical location data may be used in various ways, such as for matching service requests to service providers based on proximity, or for tracking the geolocation of the service provider during the lifecycle of a service request.

FIG. 3F shows an availability input screen where a service provider may specify their work location, the radius within which they are willing to provide services, and their availability across different days and times of the day, with options for morning, afternoon, and evening. The service provider may proceed to the next step by clicking the “Continue” button. In some cases, the onboarding process may include collecting information about the service provider's availability. The availability data may be used to match service requests to service providers based on the service providers' availability during the requested service timeframe.

In some aspects, the user interfaces shown in FIGS. 3E-3F may facilitate the onboarding of service providers by providing a straightforward and user-friendly process for entering personal information and specifying availability. The clear and intuitive design of the user interfaces may enable service providers to quickly and efficiently enter their personal information and specify their availability, thereby enhancing the user experience and contributing to the overall efficiency and effectiveness of the services lifecycle management and tracking process.

Referring to FIGS. 3G-3H, example user interfaces for onboarding service providers in the context of interpreter services lifecycle applications and environments are depicted. In some aspects, FIG. 3G shows a user interface where a service provider may select their area of expertise from a list of options. These options may include, but are not limited to, Medical Interpreter Certification, Community Interpreter Certification, American Sign Language, Court Interpreter Certification, Medical Qualified, and Document Translation. The service provider may complete the selection by clicking a “Finish” button. This onboarding process may include collecting information about the service provider's credentials. The credential data may be used in various ways, such as for matching service requests to service providers based on the service providers' credentials.

FIG. 3H presents a user interface prompting the service provider to attach various files as part of their profile. These files may include, but are not limited to, a cover letter, resume, certifications, insurance documents, driver's license, and motor vehicle registration. The service provider may proceed to the next step by clicking a “Continue” button. In some cases, the onboarding process may include collecting documentation to verify the service provider's credentials. The documentation data may be used to verify the service provider's credentials and ensure that the service provider is qualified to provide the requested services.

In some aspects, the user interfaces shown in FIGS. 3G-3H may facilitate the onboarding of service providers by providing a straightforward and user-friendly process for entering personal information and specifying credentials. The clear and intuitive design of the user interfaces may enable service providers to quickly and efficiently enter their personal information, specify their credentials, and upload relevant documentation, thereby enhancing the user experience and contributing to the overall efficiency and effectiveness of the services lifecycle management and tracking process.

Referring to FIGS. 3I-3J, example user interface screens for a mobile application related to interpreter services lifecycle management are depicted. In some aspects, FIG. 3I shows a welcome screen that may be presented to a user upon launching the application. The welcome screen may include options for searching job titles, viewing popular jobs, and a list of recent jobs.

The list of recent jobs may include various types of interpretation services, such as American sign language, community interpreter, and medical interpreter. These options may facilitate user interaction with the application by providing easy access to job searches. In some cases, the welcome screen may also include a search bar or other input field that allows a user to search for specific job titles. This feature may enable a user to quickly and efficiently find jobs that match their specific skills or interests. The welcome screen may also include a list of popular jobs, which may be determined based on factors such as the number of times a job has been viewed or applied for.

This feature may help users discover new job opportunities that they may not have been aware of. FIG. 3J displays a profile management screen that may be presented to a user upon accessing their account. The profile management screen may include options for viewing and editing the profile, managing notifications, viewing past and upcoming requests, changing the password, accessing support, and logging out. These options may facilitate user interaction with the application by providing easy access to account management and support features.

In some aspects, the profile management screen may include a user profile section that displays information about the user, such as their name, profile picture, and contact information. The user may be able to edit this information by selecting an edit option. The profile management screen may also include a notifications section that displays notifications related to the user's account, such as new job postings, messages from other users, and updates from the application. The user may be able to manage these notifications by selecting a manage notifications option. In some cases, the profile management screen may also include a requests section that displays past and upcoming requests made by the user.

The user may be able to view details about these requests, such as the date and time of the request, the type of service requested, and the status of the request. The user may also be able to change their password, access support resources, and log out of their account using options provided on the profile management screen. In some aspects, the user interfaces shown in FIGS. 3I-3J may facilitate user interaction with the application by providing easy access to job searches, account management, and support features. The clear and intuitive design of the user interfaces may enhance the user experience and contribute to the overall efficiency and effectiveness of the services lifecycle management and tracking process.

Referring to FIGS. 3K-3L, example user interface screens for a service request application within a service lifecycle management system are depicted. In some aspects, FIG. 3K shows a service request interface where a user, such as a service requester, may enter the location of service on a map, select the date and time for the service, and choose the type of interpreter service desired. The type of interpreter service may include, but is not limited to, Medical Interpreter, Community Interpreter, American Sign Language, or Court Interpreter. Once the service requester has entered all the relevant details, they may submit the request. In some cases, the submission of the service request may trigger the matching engine 132 to match the request to a subset of service providers among the service providers.

The matching of the service request to a subset of service providers may be based on various factors, including but not limited to, the proximity of the service providers to the requested service location, the availability of the service providers during the requested service timeframe, and the credentials of the service providers. In some aspects, the surfacing of the subset of service providers for selection may include presenting the service requester with a list of service providers who are capable of fulfilling the service request. This list of service providers may be presented on a user interface, enabling the service requester to easily view and select a service provider from the list.

FIG. 3L displays a filter setting interface where the user may refine the search for service providers. In some cases, the user may select a category, such as American Sign Language (ASL), and specify the location radius within which the service is desired. The location radius options may range from 0.25 miles to 100 miles, providing the user with flexibility in defining the geographical scope of their service request. Once the user has selected the desired filters, they may apply the selected filters to refine the search for service providers. In some aspects, the application of the selected filters may result in a refined subset of service providers being surfaced for selection.

This refined subset of service providers may include service providers who meet the specific criteria defined by the filters, thereby enhancing the efficiency and effectiveness of the service provider matching process. Overall, the user interfaces shown in FIGS. 3K-3L may facilitate the process of making a service request and refining the search for service providers, thereby enhancing the user experience and contributing to the overall efficiency and effectiveness of the services lifecycle management and tracking process.

Referring to FIGS. 3M-3N, example user interfaces within a networked environment 10 for managing interpreter services are depicted. In some aspects, FIG. 3M shows a notification interface informing a user that they have been matched with an interpreter. The notification interface may include details of the interpreter such as name, credentials, and location. In some cases, the notification of the service provider of the selection may include sending a digital message to the service provider's computing device. This digital message may contain information about the service request, including the service type, service date, service timeframe, and service location.

FIG. 3N presents a map interface displaying the service provider route 12, indicating the path an interpreter will take to reach the job location, along with job details including the interpreter's name and credentials. The service provider route 12 may be determined based on the geolocation data of the service provider. In some aspects, the tracking of geolocation data of the service provider after receipt of the start acceptance may include using GPS technology to monitor the service provider's location in real-time. This real-time tracking of the service provider's location may enable the system to provide the service requester with an estimated arrival time of the service provider. In some cases, the notifying of the service requester of the start acceptance and the estimated arrival of the service provider based on the geolocation data may include sending a digital message to the service requester's computing device.

This digital message may contain information about the start acceptance and the estimated arrival time of the service provider, thereby providing the service requester with real-time updates about the status of the service request. In some aspects, the receiving of an arrival confirmation from the service provider may include the service provider manually confirming their arrival at the service location through a computing device.

Similarly, the receiving of a services completion confirmation from the service provider may include the service provider manually confirming the completion of the service through a computing device. These manual confirmations may provide additional assurance to the service requester that the service has been successfully completed. Overall, the user interfaces shown in FIGS. 3M-3R may facilitate the process of notifying users about interpreter matches and providing route information for service fulfillment within the networked environment 10. The clear and intuitive design of the user interfaces may enhance the user experience and contribute to the overall efficiency and effectiveness of the services lifecycle management and tracking process.

The services lifecycle application can enhance network bandwidth utilization through a variety of algorithms and techniques designed to optimize data transmission. Lossless data compression algorithms can be employed to minimize the size of data packets without sacrificing information, which is particularly useful for text-based communications such as notifications. For less sensitive data, lossy compression may be acceptable to achieve even greater reductions in data size.

To optimize data transmission, the system can send incremental updates to client devices, ensuring that they receive just the new or changed data since their last update. Adaptive data synchronization can also be used, which adjusts data transfers based on current network conditions and the priority of the data, thus avoiding unnecessary bandwidth usage.

Caching is another effective strategy. By storing frequently accessed data locally on client devices or using edge caching, the system can reduce the number of data requests that travel back to the central server, thereby conserving bandwidth and improving response times.

Network traffic management techniques such as traffic shaping and load balancing can prioritize time-sensitive data and distribute network traffic to prevent congestion. Predictive analytics can be leveraged to anticipate peak usage times, allowing the system to allocate resources in advance to handle surges in demand without overwhelming the network.

Efficient network protocols, such as QUIC, which combines the speed of UDP with the reliability of TCP, can be utilized to enhance data transfer efficiency. Protocol compression can further reduce the size of network packets by compressing headers and payloads.

Content Delivery Networks (CDNs) can be used to distribute static content, reducing the load on the origin server and decreasing latency for end-users. Additionally, bandwidth throttling at the user level can prevent any single user from consuming an excessive share of the available bandwidth. By integrating these various approaches, the services lifecycle application can ensure that network bandwidth is used effectively, maintaining efficient and reliable communication between all parties involved in the service lifecycle.

To reduce CPU or GPU usage in the services lifecycle application, several algorithmic routines can be implemented. One approach is to optimize the matching algorithms that pair service requests with providers. By refining these algorithms to be more efficient, the computational load can be reduced, thereby conserving CPU cycles. For instance, using more efficient data structures, such as hash maps for quick lookups or implementing algorithms such as binary search trees, can speed up the matching process. Another method can include use of lazy loading, where data is loaded on-demand rather than pre-loaded, which can prevent the CPU from processing large amounts of data that may not be immediately necessary. This approach can be particularly effective in user interface rendering, where off-screen elements are not processed until they are likely to be viewed.

The services lifecycle application can implement batch processing, where data processing tasks are accumulated and processed as a batch to optimize the use of CPU or GPU cycles. This can be more efficient than processing each task individually, as it reduces the overhead associated with task switching and allows for better utilization of the processor's capabilities. Additionally, parallel processing can be utilized to distribute computational tasks across multiple CPU or GPU cores. By breaking down tasks into smaller, concurrent operations that can run in parallel, the overall processing time can be reduced, and the workload can be balanced more effectively across the available hardware resources.

Algorithmic improvements in memory management can also lead to reduced CPU usage. For example, implementing garbage collection algorithms that more efficiently identify and reclaim unused memory can prevent memory leaks and reduce the burden on the CPU to manage memory. Finally, predictive analytics can be used to anticipate resource-intensive operations and allocate CPU or GPU resources proactively. By predicting when and where heavy computational loads will occur, the system can adjust its resource allocation in real time to smooth out spikes in CPU or GPU demand. By incorporating these optimizations, the services lifecycle application can minimize CPU and GPU usage, leading to a more efficient and responsive system that better manages its computational resources.

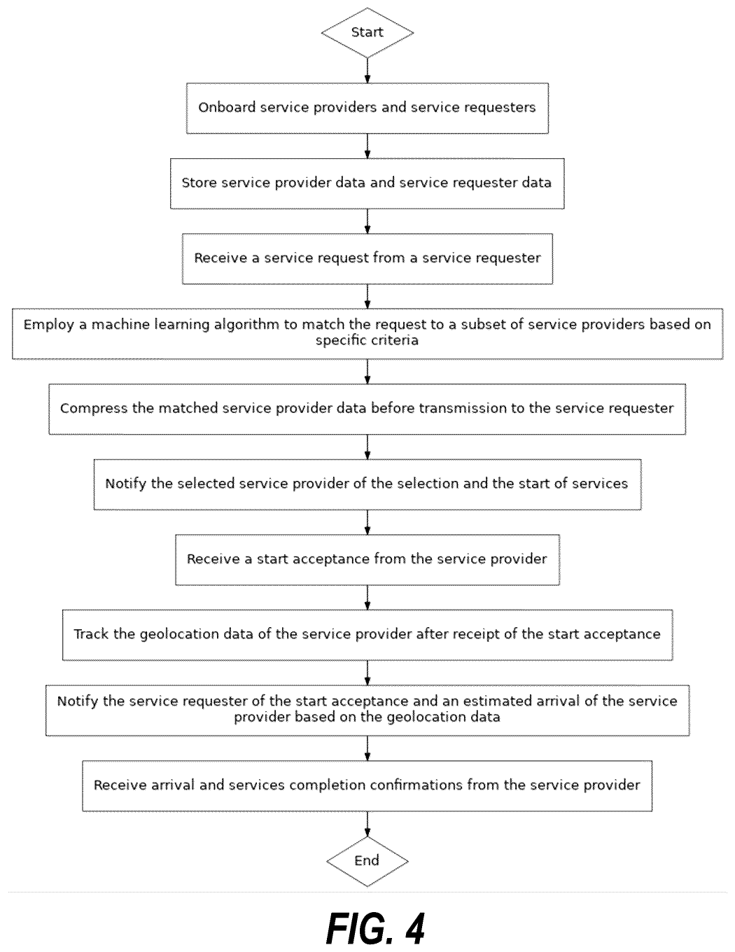

Referring to FIG. 4, an exemplary flowchart of a method for managing service provider lifecycles within interpreter services lifecycle applications and environments is illustrated. The method commences with the initiation of the onboarding process for service providers and service requesters, ensuring that all relevant data such as credentials, availability, and geographical location are collected and stored. This foundational step is pivotal for the subsequent matching of service requests with the appropriate service providers.

As the method progresses, a service request is received from a service requester, which triggers the matching engine to employ a machine learning algorithm. This algorithm is adept at analyzing the request against a set of specific criteria to identify a subset of service providers who are suitably matched to the service request. The criteria may include factors such as proximity, availability, and credentials, as well as machine learning predictions based on historical data.

Once a subset of service providers is determined, the matched service provider data is compressed using lossless data compression techniques before transmission to the service requester. This step is instrumental in reducing the size of the data packets transmitted over the network, thereby conserving bandwidth and enhancing transmission efficiency.

Upon the selection of a service provider by the service requester, the lifecycle engine notifies the selected service provider of their selection and the commencement of services. A start acceptance is then received from the service provider, which sets in motion the tracking of the service provider's geolocation data. This real-time tracking is facilitated by GPS technology, enabling the system to provide the service requester with an estimated arrival time of the service provider.

The method concludes with the lifecycle engine receiving confirmations from the service provider regarding their arrival at the service location and the completion of the services. These confirmations are typically received through manual input by the service provider via a computing device, thereby ensuring the service requester is apprised of the service status.

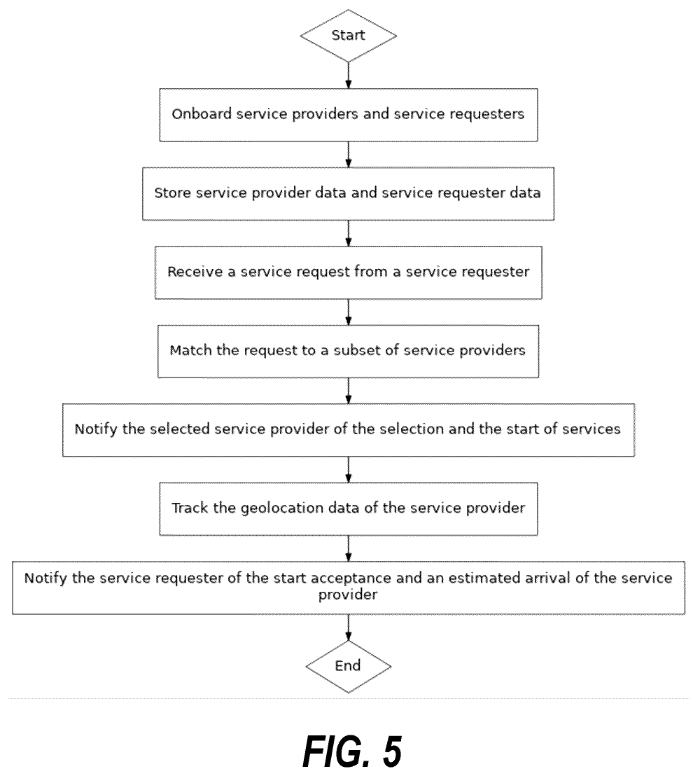

FIG. 5 presents a flowchart of a method for managing service provider lifecycles within a networked environment. This method encapsulates the full spectrum of steps from the onboarding of service providers and service requesters to the final confirmation of service completion. The method is designed to streamline the lifecycle management process, ensuring that service providers are efficiently matched to service requests and that service requesters are kept informed of the progress of their requests.

The method includes storing detailed service provider and service requester data, which is then utilized to match service requests with the appropriate service providers based on a range of criteria. The lifecycle engine plays a central role in notifying service providers of their selection, tracking their geolocation data, and communicating with service requesters about the status of the service request, including start acceptances and estimated arrival times.

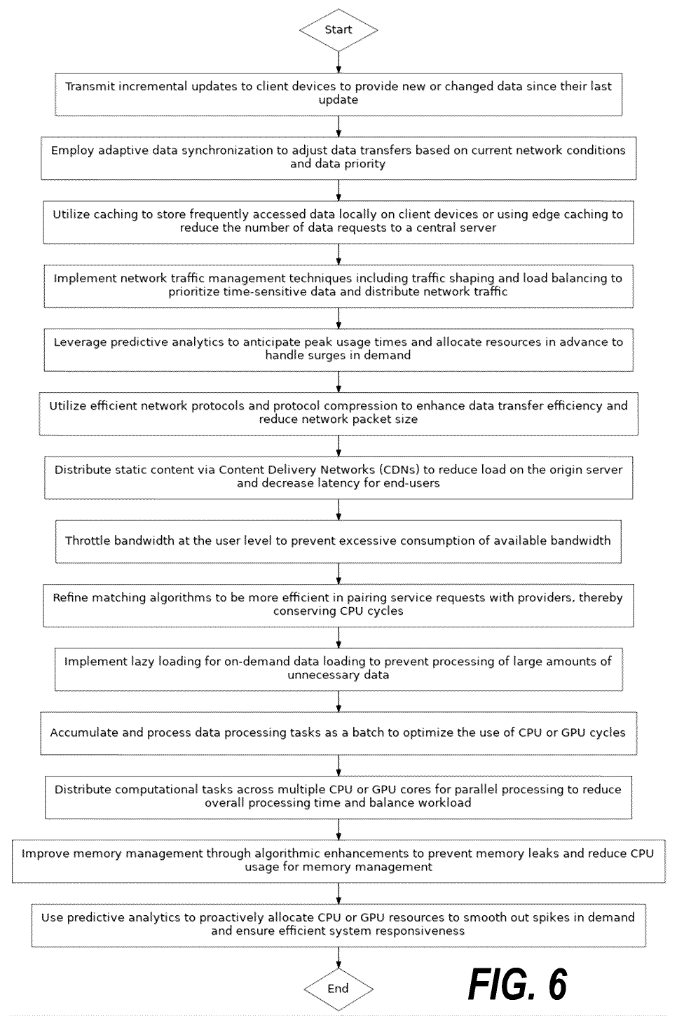

FIG. 6 depicts a flowchart of a method for optimizing network bandwidth and reducing CPU or GPU usage in a services lifecycle application within a networked environment. This method is particularly focused on enhancing the performance and efficiency of the computing resources involved in the services lifecycle application.

The method includes a series of steps that collectively contribute to the optimization of network bandwidth and the reduction of CPU or GPU usage. These steps include the transmission of incremental updates to client devices, adaptive data synchronization based on network conditions and data priority, and the use of caching to reduce the number of data requests to the central server.

Network traffic management techniques are employed to ensure that time-sensitive data is prioritized and that network traffic is balanced to prevent congestion. Predictive analytics are used to forecast peak usage times, allowing for the proactive allocation of resources. Efficient network protocols and protocol compression are utilized to improve data transfer efficiency, and static content is distributed via Content Delivery Networks (CDNs) to reduce latency for end-users.

The method also includes strategies to refine matching algorithms for efficiency, implement lazy loading to prevent unnecessary data processing, and utilize parallel processing to distribute computational tasks across multiple CPU or GPU cores. Memory management is enhanced through algorithmic improvements, and predictive analytics are used to allocate CPU or GPU resources effectively, ensuring a responsive and efficient system.

The client devices or other computing devices comprising a computing environment can include at least one processor circuit, for example, having a processor and at least one memory device, both of which are coupled to a local interface, respectively. The device can include, for example, at least one computer, a mobile device, smartphone, computing device, or like device. The local interface can include, for example, a data bus with an accompanying address/control bus or other bus structure.

Stored in the memory device are both data and several components that are executable by the processor. In particular, stored in the one or more memory devices and executable by the device processor can be the client application, and potentially other applications. Also stored in the memory can be a data store and other data.

A number of software components are stored in the memory and executable by a processor. In this respect, the term “executable” means a program file that is in a form that can ultimately be run by the processor. Examples of executable programs can be, for example, a compiled program that can be translated into machine code in a format that can be loaded into a random access portion of one or more of the memory devices and run by the processor, code that can be expressed in a format such as object code that is capable of being loaded into a random access portion of the one or more memory devices and executed by the processor, or code that can be interpreted by another executable program to generate instructions in a random access portion of the memory devices to be executed by the processor. An executable program can be stored in any portion or component of the memory devices including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

Memory can include both volatile and nonvolatile memory and data storage components. Also, a processor can represent multiple processors and/or multiple processor cores, and the one or more memory devices can represent multiple memories that operate in parallel processing circuits, respectively. Memory devices can also represent a combination of various types of storage devices, such as RAM, mass storage devices, flash memory, or hard disk storage. In such a case, a local interface can be an appropriate network that facilitates communication between any two of the multiple processors or between any processor and any of the memory devices. The local interface can include additional systems designed to coordinate this communication, including, for example, performing load balancing. The processor can be of electrical or of some other available construction.

The client devices can include a display upon which a user interface generated by a client application can be rendered. In some examples, the user interface can be generated using user interface data provided by the computing environment. The client device can also include one or more input/output devices that can include, for example, a capacitive touchscreen or other type of touch input device, fingerprint reader, or keyboard.

Although the various methods, systems, services, engines, and so forth, described herein can be embodied in software or code executed by general-purpose hardware as discussed above, as an alternative the same can also be embodied in dedicated hardware or a combination of software/general purpose hardware and dedicated hardware.

Although the sequence diagram flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the drawings can be skipped or omitted.

Also, any logic or application described herein that includes software or code can be embodied in any non-transitory computer-readable medium for use by or in connection with an instruction execution system such as, for example, a processor in a computer system or other system. In this sense, the logic can include, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

It is emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure.

Therefore, the following is claimed:

1. A system for managing service provider lifecycles in a networked environment, comprising:
a computing environment configured to onboard service providers and service requesters and store their data;
a matching engine configured to receive a service request from a service requester and match the request to a subset of service providers based on specific criteria;
a lifecycle engine configured to notify the selected service provider of the selection and the start of services, receive a start acceptance from the service provider, track the geolocation data of the service provider after receipt of the start acceptance, notify the service requester of the start acceptance and an estimated arrival of the service provider based on the geolocation data, and receive arrival and services completion confirmations from the service provider.

2. The system of claim 1, wherein the specific criteria used by the matching engine comprises at least one of: proximity of the service providers to the requested service location, availability of the service providers during the requested service timeframe, and credentials of the service providers.

3. The system of claim 2, wherein the lifecycle engine is further configured to provide real-time updates to the service requester and the service provider about the status of the service request.

4. A system for managing service provider lifecycles in a networked environment, the system comprising:
a computing environment;
a matching engine configured to receive a service request from a service requester and match the request to a subset of service providers; and
a lifecycle engine configured to notify the selected service provider of the selection and the start of services, track the geolocation data of the service provider, and notify the service requester of the start acceptance and an estimated arrival of the service provider.

5. The system of claim 4, wherein the matching engine is further configured to match the service request to the subset of service providers based on at least one of: proximity of the service providers to the requested service location, availability of the service providers during the requested service timeframe, and credentials of the service providers.

6. The system of claim 5, wherein the lifecycle engine is further configured to provide real-time updates to the service requester and the service provider about the status of the service request.

7. The system of claim 4, wherein the computing environment is further configured to distribute the workload across multiple servers or processing units, ensuring that no single device is overwhelmed.

8. The system of claim 4, wherein the computing environment is further configured to employ data normalization and indexing within a cloud-based data store to streamline data retrieval and minimize storage overhead.

9. The system of claim 4, wherein the computing environment is further configured to send notifications and updates in a compressed format, reducing the size of data packets transmitted over the network.

10. The system of claim 4, wherein the computing environment is further configured to implement caching mechanisms to store frequently accessed data locally on the computing device, reducing the number of repeated queries to the server.

11. The system of claim 4, wherein the computing environment is further configured to synchronize data between the service provider and service requester based on network conditions and data priority.

12. The system of claim 4, wherein the computing environment is further configured to analyze historical data and usage patterns to predict peak times and pre-allocate resources accordingly.

13. A method for managing service provider lifecycles in a networked environment, comprising:
onboarding, by at least one computing device comprising at least one hardware processor, service providers and service requesters;
storing, by the at least one computing device, service provider data and service requester data;
receiving, by the at least one computing device, a service request from a service requester;
employing, by the at least one computing device, a machine learning algorithm to match the request to a subset of service providers based on specific criteria;
compressing, by the at least one computing device, the matched service provider data before transmission to the service requester;
notifying, by the at least one computing device, the selected service provider of the selection and the start of services;
receiving, by the at least one computing device, a start acceptance from the service provider;
tracking, by the at least one computing device, the geolocation data of the service provider after receipt of the start acceptance;
notifying, by the at least one computing device, the service requester of the start acceptance and an estimated arrival of the service provider based on the geolocation data; and
receiving, by the at least one computing device, arrival and services completion confirmations from the service provider.

14. The method of claim 13, wherein the onboarding of service providers and service requesters includes collecting information about the service providers and service requesters, such as their credentials, availability, geographical location, and other relevant details.

15. The method of claim 14, wherein the geographical location data is used for matching service requests to service providers based on proximity.

16. The method of claim 14, wherein the availability data is used to match service requests to service providers based on the service providers' availability during the requested service timeframe.

17. The method of claim 13, wherein the matching of the service request to a subset of service providers is based on specific criteria including at least one of: proximity of the service providers to the requested service location, availability of the service providers during the requested service timeframe, credentials of the service providers, and machine learning predictions based on historical data.

18. The method of claim 13, wherein the tracking of the geolocation data of the service provider after receipt of the start acceptance comprises using GPS technology to monitor the service provider's location in real-time.

19. The method of claim 18, wherein the real-time tracking of the service provider's location enables the system to provide the service requester with an estimated arrival time of the service provider, and the arrival and services completion confirmations from the service provider are received through manual confirmations by the service provider via a computing device.

20. The method of claim 13, wherein the machine learning algorithm is configured to learn and adapt over time to improve the accuracy of matching service requests with service providers based on the specific criteria, and the data compression comprises employing lossless data compression techniques to reduce the size of the matched service provider data without loss of information before transmission to the service requester.

21. A method for optimizing network bandwidth and reducing CPU or GPU usage in a services lifecycle application within a networked environment, the method comprising:
transmitting incremental updates to client devices to provide new or changed data since their last update;
employing adaptive data synchronization to adjust data transfers based on current network conditions and data priority;
utilizing caching to store frequently accessed data locally on client devices or using edge caching to reduce the number of data requests to a central server;
implementing network traffic management techniques including traffic shaping and load balancing to prioritize time-sensitive data and distribute network traffic;
leveraging predictive analytics to anticipate peak usage times and allocate resources in advance to handle surges in demand;
utilizing efficient network protocols and protocol compression to enhance data transfer efficiency and reduce network packet size;
distributing static content via Content Delivery Networks (CDNs) to reduce load on the origin server and decrease latency for end-users;
throttling bandwidth at the user level to prevent excessive consumption of available bandwidth;
refining matching algorithms to be more efficient in pairing service requests with providers, thereby conserving CPU cycles;
implementing lazy loading for on-demand data loading to prevent processing of large amounts of unnecessary data;
accumulating and processing data processing tasks as a batch to optimize the use of CPU or GPU cycles;
distributing computational tasks across multiple CPU or GPU cores for parallel processing to reduce overall processing time and balance workload;
improving memory management through algorithmic enhancements to prevent memory leaks and reduce CPU usage for memory management; and
using predictive analytics to proactively allocate CPU or GPU resources to smooth out spikes in demand and ensure efficient system responsiveness.
